(19) United States
(12) Patent Application Publication
(10) Pub. No.: US 2016/0314655 A1
(43) Pub. Date: Oct. 27, 2016

(54) ADVERTISING METHOD COMBINING GAME SOFTWARE IN A MOBILE DEVICE

(71) Applicants: GARRY TSAUR, Rowland Heights, CA (US); BANKER TSAUR, Rowland Heights, CA (US); CHIEN-HUA TSAO, TAIPEI (TW); TA-WEI TSAO, NEW TAIPEI CITY (TW)

(72) Inventors: GARRY TSAUR, Rowland Heights, CA (US); BANKER TSAUR, Rowland Heights, CA (US); CHIEN-HUA TSAO, TAIPEI (TW); TA-WEI TSAO, NEW TAIPEI CITY (TW)

(21) Appl. No.: 14/696,675

(22) Filed: Apr. 27, 2015

(51) Int. Cl. G07F 17/32; G06Q 30/02; G07F 17/34

(52) U.S. Cl. CPC G07F 17/3255; G07F 17/3218; G07F 17/34; G06Q 30/0267

(57) ABSTRACT

An advertising method combining game software in a mobile device includes a game software activated in a mobile device and displayed on a game screen on which game icons with ad icons for an advertising theme mixed are deployed so that the ad icons enabled with the game icons are repeatedly and constantly seen by and impressed on a game player operating game icons of the game software for advertising effects.

### BACKGROUND OF THE INVENTION

1. Field of the Invention

The present disclosure relates to mobile commerce, particularly a commercial method combining game software in a mobile device for advertising effects and real benefits of a game company, an advertiser and game players.

2. Description of the Prior Art

People depend on the Internet gradually when technologies related to the Internet get progress. For example, an individual's routine jobs from morning such as reading news, listening music, chatting with friends, purchasing consumer goods, coordinating work and querying for data are almost related to the Internet which has been regarded as most persons' important partner in their daily lives.

Popularity of portable electronic devices such as mobile phone and tablet computer further drives the Internet to be developed. Traditionally, people who surf the Internet at homes or offices through their computers linking the network are limited to specific time or locations. Currently, the Internet conveniently accessed by most people through progressive portable electronic devices anytime and anywhere evolves into another peak.

Lots of businessmen who have run brick-and-mortar stores also open online stores one after another for further profits because more business opportunities stem from those newly developed consumer sources. In contrast to a traditional concept, the start-ups prefer online stores to traditional brick-and-mortar ones in the beginning for fewer rentals and more benefits.

Compared with tens of thousands new messages posted on the spacious Internet everyday, one commodity which was not publicized properly may be overwhelmed in the vast Internet quickly and not presented to customers.

Therefore, businessmen chasing profits increasingly value Internet-based advertising. The good advertising spaces, which incur considerable expenses and are bidden by thousands of business operators, drive creation of some extremely wealthy Internet giants at a breathtaking pace.

Currently, the propagation of Internet advertising is based on traditional modes such as ads activated at corners of a web page or pop-up ads which are intrusive ads promoting limited effect but abhorred by Internet users. An alternative advertising method similar to the trick of a TV commercial broadcasted with a TV program simultaneously is unfavorable to advertisement because of the sight of viewers adversely influenced.

Among existing Internet-based applications, the fascinating online games always attract a considerable proportion of game amateurs regardless of genders and ages and imply large business opportunities. Therefore, some advertisers prefer investing game companies for more advertising chances on games; a game company financed by other lenders charges game players fewer money or allows game players to play games freely for a larger scale of game players. As such, three parties including the advertiser, the game company and game players benefit from an Internet game.

However, the advertising effect may not be satisfactory in each of thousands of online games. It is inappropriate to insert an advertising screen into an activated RPG game which is characteristic of sophisticated images and game effects. The placement advertising in changeable game scenes may be poorly recognized and even adversely affect fluent motions of images. Moreover, most games with exquisite image quality and smooth movement are available in PCs but not in portable electronic devices and have limited advertising effects.

Having considered previous drawbacks, the patent applicant researched and developed an advertising method combining game software in a mobile device to increase authentic values of online advertisement.

### SUMMARY OF THE INVENTION

The present disclosure describes an advertising method combining game software in a mobile device wherein an advertising theme cleverly integrated with game software is highlighted effectively but does not adversely influence a game player playing a game.

The present disclosure further describes an advertising method combining game software in a mobile device by which a game company makes profits, an advertiser presents an advertising theme effectively and game players have rights to use game software for free. Therefore, the three parties take what they need and benefit from game software.

For these purposes, an advertising method combining game software in a mobile device is enabled on portable electronic devices as carriers including mobile phones, tablet computers and handheld electronic entertainment devices linking the Internet on which game software is activated. A game company negotiates with an advertiser for displaying an advertising theme on a game screen related to game software and charges the advertiser for running the game software. As such, a game company makes profits, an advertiser presents an advertising theme efficiently, and game players have rights to use game software for free. Therefore, the three parties including the game company, the advertiser and the game players take what they need and benefit from game software.

An advertising method combining game software in a mobile device comprises steps as follows: a game company provides game software that is activated in a mobile device and displays game icons on a game screen in which ad icons for an advertising theme are mixed; a game player controls the game software through which both the ad icons for an advertising theme and the game icons are activated simultaneously and seen by and impressed on the game player repeatedly, constantly and effectively.

For the advertising method mentioned above, a game company should negotiate with an advertiser for a charge mechanism such as duration of ad icons displayed and quantity thereof, timing of settlement, payment terms, etc. Based on the charge mechanism, a game company makes statistics such as frequency of ad icons displayed on a game screen and charges an advertiser.

An advertising method combining game software in a mobile device without troubles of a traditional advertising mode interrupting a game player playing a game prefers puzzle games and casual games that are characteristic of a fixed frame on a game screen in which lots of game icons are deployed and the game icons which are controllably related to one another and regarded as components for winning or losing a game. Because the game icons are main parts of the game software for attracting game players, an advertising theme consists of ad icons with the same format of the game icons in which the ad icons to be highlighted are appropriately deployed and incorporated so that the advertising theme is displayed smoothly and properly but does not interrupt a game player deliberately.

A game company which statistically surveys acceptability of game players operating the game software for an advertising theme should negotiate with an advertiser for adjusting the frequency of ad icons displayed or changing other ad icons without antipathy of the game players to the game software.

The acceptability of a game player for an advertising theme displayed on the same game screen will be increased through one or more types of diversified ad icons. Furthermore, the ad icons can be animated images which reinforce vivid rhythm and impression of a game player.

Alternatively, ad patterns related to an advertising theme can be properly deployed on a game screen in which there is no game icon locally.

Moreover, another reward mechanism is possibly added into the course of a player of the game software winning or losing a game so that the game software is further accessed and received by a game player for increased real effects of an advertising theme. The steps are described as follows: a game company negotiates with an advertiser for a reward mechanism; a player operating the game software and wining a game which is related to ad icons earns additional prizes or scores and has more impression on an advertising theme.

Certainly, the difficulty of a reward mechanism can be increased with prizes and values of scores upgraded, for example, at least once to win a game for more prizes or scores.

### BRIEF DESCRIPTION OF THE DRAWINGS

FIG. 1 illustrates the layout of a mobile device in which game software is displayed (1);

FIG. 2 illustrates the layout of a mobile device in which game software is displayed (2);

FIG. 3 is a flow diagram which illustrates an advertising method combining game software in a mobile device;

FIG. 4 is a flow diagram for charging of an advertising method combining game software in a mobile device; and

FIG. 5 is a flow diagram for a reward mechanism of an advertising method combining game software in a mobile device.

### DETAILED DESCRIPTION OF THE PREFERRED EMBODIMENT

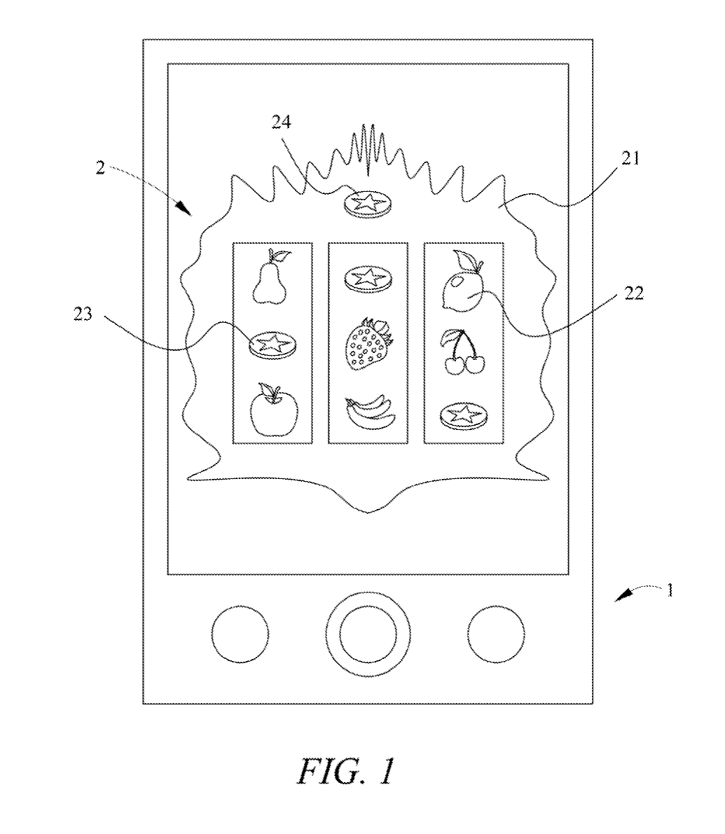

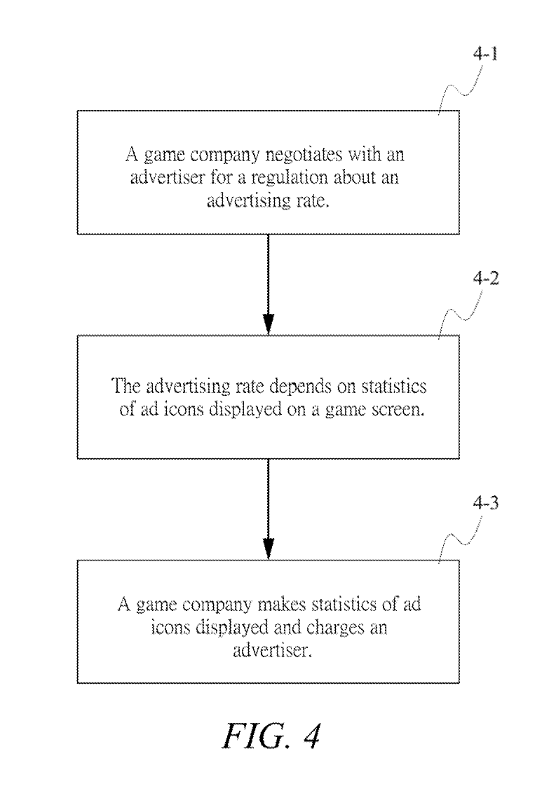

Referring to FIGS. 1 and 4 which illustrate an advertising method combining game software in a mobile device: a mobile device 1 is a portable electronic device (mobile phone, tablet computer or handheld electronic entertainment device) which links the Internet for playing an online game; game software 2 is an online game with functions such as scoring and reward designed by a game company for attracting game players interested in game software.

Through transactions between a game company and an advertiser, a game screen 21 of the game software 2 is configured to display an advertising theme by which the advertiser is charged for service of the game software 2. As such, the game company allows more and more game players to play the game software 2 for free.

A game company which profits from an advertising method combining game software in a mobile device is able to maintain service of the game software 2 or develop other better online games; an advertiser attracts more game players to perceive an advertising theme displayed with game software and further boosts sales of tie-ins; a game player who plays the game software 2 for free and are rewarded by a game company will prefer the game software 2 increasingly. Therefore, a game company, an advertiser and game players take what they need and benefit from the game software 2.

To manifest the purposes of the present disclosure, an advertising method combining game software in a mobile device should display and frequently highlight an advertising theme without antipathy from a game player who might be interrupted by the advertisement theme in the course of playing the game software 2. Preferably, the game software 2 in the present disclosure should be defined as a specific type of game such as puzzle game and casual game that are characteristic of the game screen 21 with a fixed frame in which lots of game icons 22 are deployed and the game icons 22 which are related to one another and regarded as components for winning or losing a game. Because the game icons 22 are main parts of the game software 2 for attracting game players, an advertising theme consists of ad icons 23 with the same format of the game icons 22 in which the ad icons 23 to be highlighted are appropriately deployed and incorporated for the advertising theme displayed smoothly and properly but not interrupting a game player deliberately.

In addition, the game software 2 such as puzzle game and casual game is characterized as a competitive game with the game icons 22 rotating quickly and the game screen 21 changed dozens in a flash for more advertising effects through lots of ad icons 23 displayed repeatedly and constantly.

As shown in FIG. 1, the so-called puzzle game in the game software 2 can be a usual matching game which relies on two opened game icons 22 identical to each other and is finished by a winner with the matching process of all game icons 22 on the game screen 21 completed. In the process, the game icons 22 fixed on the game screen 21 and the ad icons 23 imbedded simultaneously will be further seen by a game player.

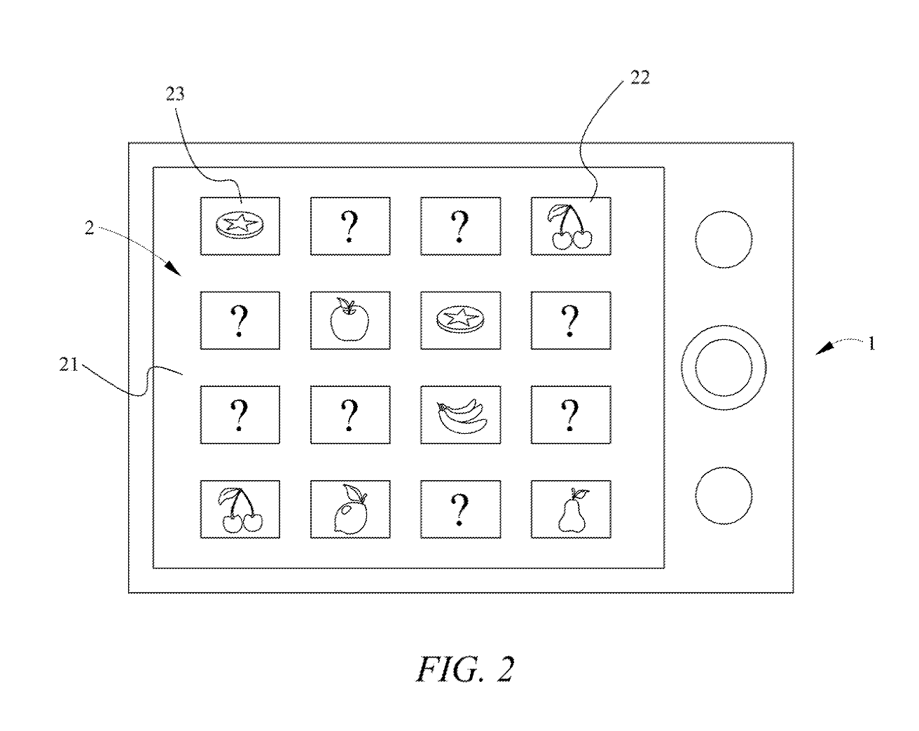

As shown in FIG. 2, the so-called casual game in the game software 2 presents a usual slot machine which is characteristic of the game icons 22 emerging randomly and identical to one another along one row, one column or one diagonal for winning when the turning game screen 21 stops. Similarly, the ad icons 23 incorporated into the game icons 22 will be further seen by a game player.

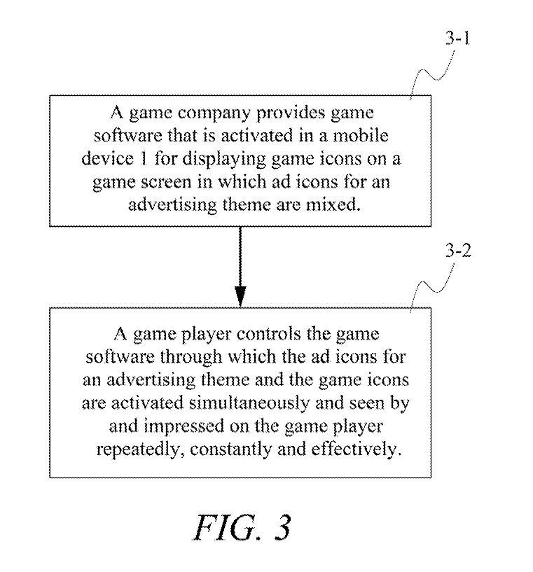

With the previous descriptions summarized, an advertising method combining game software in a mobile device comprises following steps, as shown in FIG. 3:

3-1 A game company provides game software 2 that is activated in a mobile device 1 for displaying game icons 22 on a game screen 21 in which ad icons 23 for an advertising theme are mixed;

3-2 A game player controls the game software 2 through which the ad icons 23 for an advertising theme and the game icons 22 are activated simultaneously and seen by and impressed on the game player repeatedly, constantly and effectively.

Certainly, a game company should make a regulation for charging an advertiser such as duration of the ad icons 23 displayed and quantity thereof, timing of settlement, payment terms, etc. As shown in FIG. 4, the steps are described hereinafter:

4-1 A game company negotiates with an advertiser for a regulation about an advertising rate;

4-2 The advertising rate depends on the frequency of ad icons 23 displayed on a game screen 21 as the basis of transaction between a game company and an advertiser;

4-3 A game company makes statistics of ad icons 23 displayed and charges an advertiser.

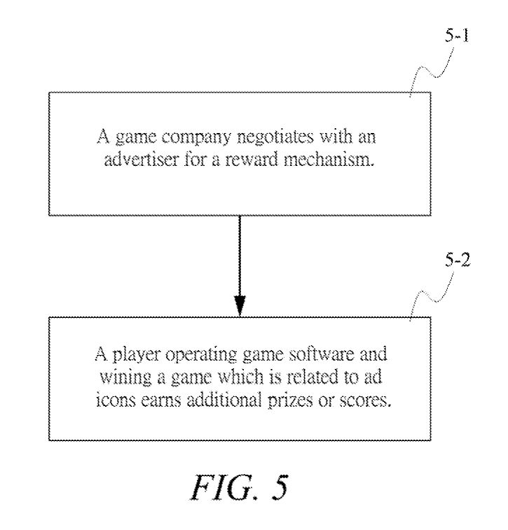

Moreover, another reward mechanism is possibly added into the course of a player of the game software 2 winning or losing a game so that the game software 2 is further accessed and received by a game player for real effects of an advertising theme. As shown in FIG. 5, the steps are described hereinafter:

5-1 A game company negotiates with an advertiser for a reward mechanism;

5-2 A player operating game software 2 and wining a game which is related to ad icons 23 earns additional prizes or scores and has more impression on an advertising theme.

Certainly, the difficulty of a reward mechanism can be increased with prizes and values of scores upgraded, for example, at least once to win a game for more prizes or scores.

A game company which statistically surveys acceptability of a player of game software 2 for an advertising theme should negotiate with an advertiser for adjusting the frequency of ad icons 23 displayed on a game screen 21 or changing other ad icons 23 without antipathy of the game player to the game software 2.

Certainly, the acceptability of a game player for an advertising theme displayed on the same game screen 21 will be increased through one or more types of diversified ad icons 23. Furthermore, the ad icons 23 can be animated images which reinforce vivid rhythm and impression of a game player.

Referring to FIG. 2 that illustrates some advertising patterns related to an advertising theme can be deployed on the game screen 21 in which there is no game icon locally.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An advertising method combining game software in a mobile device, comprising:
a game software activated in a mobile device and displayed on a game screen on which game icons with ad icons for an advertising theme mixed are deployed so that the ad icons enabled with the game icons are repeatedly and constantly seen by and impressed on a game player operating game icons of the game software for advertising effects.

2. An advertising method combining game software in a mobile device according to claim 1 wherein the game software is a puzzle game.

3. An advertising method combining game software in a mobile device according to claim 1 wherein the game software is a casual game.

4. An advertising method combining game software in a mobile device according to claim 3 wherein the casual game presents a slot machine.

5. An advertising method combining game software in a mobile device according to claim 1 wherein the ad icons displayed on the game screen can be counted statistically and taken as a basis for transactions between a game company and an advertiser.

6. An advertising method combining game software in a mobile device according to claim 1 wherein the ad icons to be displayed frequently can be adjusted by referring to statistics-based acceptability of game players for an advertising theme.

7. An advertising method combining game software in a mobile device according to claim 1 wherein the ad icons can be animated images.

8. An advertising method combining game software in a mobile device according to claim 1 wherein the ad icons can be classified into one or more types.

9. An advertising method combining game software in a mobile device according to claim 1 wherein some advertising patterns related to an advertising theme can be deployed on the game screen in which there is no game icon locally.

10. An advertising method combining game software in a mobile device according to claim 1 wherein the game software is provided with an additional mechanism of prizes or scores for an advertising theme so that a player operating the game software and wining a game which is related to ad icons earns the additional prizes or scores and has more impression on an advertising theme.

11. An advertising method combining game software in a mobile device according to claim 10 wherein a game player should win a game at least once for more prizes or scores.
